(19) United States
(12) Patent Application Publication
(10) Pub. No.: US 2026/0316159 A1
(43) Pub. Date: Oct. 15, 2026

(54) PROCESS FOR PRODUCING DRILLING TOOLS USING LASER METAL DEPOSITION AND A ROBOTIC STATION FOR PRODUCING DRILLING TOOLS

(71) Applicant: NARZEDZIA I URZADZENIA WIERTNICZE GLINK SP. Z O.O., Gorlice (PL)

(72) Inventors: Marek Burkot, Luzna (PL); Mateusz Szpak, Skolyszyn (PL); Jacek Szpyrka, Ropica Polska (PL)

(21) Appl. No.: 18/682,275

(22) PCT Filed: Dec. 22, 2023
(86) PCT No.: PCT/EP2023/087629

§ 371 Date: Feb. 8, 2024

(51) Int. Cl. B22F 10/25; B22F 5/00; B22F 7/08; B23K 26/342; B33Y 10/00; B33Y 30/00; B33Y 70/10; B33Y 80/00

(52) U.S. Cl. CPC B22F 10/25; B22F 7/08; B23K 26/342; B22F 2005/001; B22F 2302/10; B33Y 10/00; B33Y 30/00; B33Y 70/10; B33Y 80/00

(57) ABSTRACT

A process of producing drilling tools, in particular a cone details, using an additive manufacturing method in the laser metal deposition (LMD) process, includes the following steps: preheating the cone to a temperature ranging from 150 to 350° C., mounting a heated cone on the two-axis positioner (4), feeding a composite powder to a powder nozzle of a process head (9) through the powder feeder (6), wherein the powder containing 32-48 vol % nickel matrix, 12-18 vol % TiB₂ and 40-50 vol % tungsten carbide particles, melting the composite powder with a fiber laser light beam (1) with a nominal output power of 5,000 to 10,000 W, while melting the substrate, cladding of cone details using the process head (11), with a cladding speed of 4 to 9 mm/s, during which the layer of molten powder integrates with the substrate or previous cladded layers, repeating the cycle until no more than 3 cladded layers are obtained with a total thickness of 1.4 to 4 mm. The invention also relates to a robotic station for producing drilling tools.

### TECHNICAL FIELD

The present invention relates to a cladding method using a fiber laser and an additive manufacturing method. More specifically, the invention relates to a device for cladding using a fiber laser in the laser metal deposition (LMD) process in the production of steel products, e.g. drilling tools.

### BACKGROUND ART

A fiber laser is a technologically advanced tool that uses intense laser light transmitted through a highly flexible fiber. In an additive manufacturing method such as laser metal deposition (LMD), a laser precisely gradually deposits metal material layer by layer, creating durable and precise components. Fiber laser cladding equipment is crucial in the production of steel products, such as drilling tools, enabling precise and durable finishes, which increases the quality and durability of the final products.

Laser metal deposition (LMD) technology using fiber lasers offers a number of benefits. First of all, it ensures excellent precision, enabling the creation of complex shapes and very accurate details even in hard-to-reach places. Moreover, this process minimizes material waste because the metal material is applied exactly where it is needed, which translates into efficient use of raw materials.

Another important advantage is the speed and efficiency of manufacturing—laser metal deposition allows quickly create or repair parts, which can significantly shorten the time needed to produce a specific product. Moreover, the use of this technology often reduces the need for finishing operations, which in reduces the total production time and costs associated with finishing operations. Ultimately, products obtained using this technology are often more durable and resistant, which is a significant advantage in the case of drilling tools where durability is a key factor.

The state of the art provides many solutions for the use of fiber lasers and additive manufacturing methods in the production of steel products.

U.S. Ser. No. 10/641,045B2 discloses a metal matrix composite (MMC) tool comprising a reinforced composite part that includes mesoscale reinforcement structures dispersed in a binder material. These structures are printed using additive manufacturing techniques using the LMD method. However, the disclosed solution does not provide the possibility of using a fiber laser as a radiation source.

US20200047253A1 discloses a method of manufacturing a drill bit that includes creating a three-dimensional porous metal workpiece by an additive manufacturing process including LMD technology. The disclosed solution does not provide the application of a fiber laser.

Document CN113795603B discloses the use of nickel-based alloys in the creation of excavator drill bits. The incremental forming method, including the use of LMD technology, is used to create this type of tools. This process involves the use of fiber lasers with specific output power, scanning speed and precise powder feed rate, which is detailed in the document.

Document EP3397911A1 discloses a drill bit for use in a tapped hole drill and describes a method of manufacturing the same. The production technique of this drill is based on the additive manufacturing method. The additive method uses a fiber laser capable of melting fine metal powder, where the powder used is a nickel alloy.

EP3332080B1 discloses a method for forming earth drilling tools, including, but not limited to: for conical drills, using a device with a multi-axis positioning system that allows direct metal deposition. According to the disclosure, the metal deposition tool may include a 3D printer and an associated source of metal that can be melted to create 3D printed layers. The 3D printer can be equipped with a heat source with appropriate power to melt metal or metal alloy, e.g. ytterbium fiber laser.

The purpose of the invention is to provide a process for creating steel products, in particular cone details, using the additive manufacturing method in the laser metal deposition (LMD) process, wherein due to the appropriate selection of fiber laser parameters, it is possible to generate a laser beam adapted to the entire cladding process.

The invention relates to a process for producing drilling tools, in particular biting details, using the additive manufacturing method in the laser metal deposition (LMD) process and includes the following stages:
preheating the cone to a temperature ranging from 150 to 350° C.;
mounting the heated cone on a two-axis positioner;
feeding the composite powder to the powder nozzle of the process head through the powder feeder, wherein the powder containing 32-48 vol % nickel matrix, 12-18 vol % TiB₂ and 40-50 vol % tungsten carbide particles;
melting the composite powder with a fiber laser light beam with a nominal output power of 5,000 to 10,000 W, while the substrate is melting simultaneously;
cladding of cone details using a process head at a cladding speed of 4 to 9 mm/s, during which the layer of molten powder integrates with the substrate or previous cladded layers;
repeating the all previous steps until no more than 3 cladded layers are obtained with a total thickness of 1.4 to 4 mm;

Preferably, the laser radiation wavelength is from 900 to 1080 nm, the laser power is from 1150 to 1550 W, the laser spot diameter is from 4 to 8 mm.

Preferably, the gradation of the composite powder is from 45 to 250 μm and the powder flow is from 20 to 30 g/min.

Preferably, the powder melting efficiency is from 55 to 85%.

In a second aspect, the invention relates to a cladded layer.

Preferably, the cladded layer has an impact resistance KCV of 46.6 J/cm².

Preferably, the cladded layer has a density of 9.899 g/cm³.

Preferably, the cladded layer has an abrasive wear resistance according to the ASTM G-65 standard of 0.05 g.

In another aspect, the invention relates to a robotic station for producing drilling tools, containing a six-axis industrial robot for performing operations with the LMD process head, a powder nozzle cooler for the process head, a robot controller and an IT cabinet managing the robot's movement, a fiber laser source providing light energy to melt the composite powder fed by powder feeder, two-axis positioner setting the elements in appropriate positions during the surfacing process, a cooler for the laser source and optics, a central control unit for controlling the components of the robotic station, an operator panel, a filter-ventilation system that cleans the interior of the chamber from dust generated during the surfacing process, and a protective cabin.

The present invention describes a cladding device using a fiber laser and an additive manufacturing method (LMD). It was developed on the basis of a robotic station, and the material used in the technology is a cladding powder with gradient properties.

The robotic station enables the industrial application of LMD technology with a fiber laser to design a full-scale robotic system of a station where the cladding process is carried out, adapted for continuous use in industry. This process can be carried out on the details of three-bit drill bits (large-diameter), i.e. bits and on the heads of PDC (Policrystalline Diamond Compact) drill bits and other elements of the drill string.

The laser process head is adapted to the geometry of the drill components (three-bit drill and PDC drill) so that the cladding process becomes possible.

The use of appropriately selected gradient powder compositions enables the construction and development of a system and method of cladding drill bit details that meets the highest standards in terms of material quality. The present invention applied nickel-based powders, e.g. disclose in patent application PL436889A1. The powders used have the following composition: 32-48 vol % nickel matrix, 12-18 vol % TiB₂ and 40-50 vol % tungsten carbide particles.

The program assigned to a specific detail ensures reading of all necessary process parameters as well as settings/corrections necessary to perform a repeatable and error-free process. This correction is due to the different types and sizes of bit details and the 3D geometry of the cladded component. A wide range of sizes and geometries of details resulted in the need to develop a process head nozzle design that would be suitable and would enable access to almost 100% of the working surface of the cladded detail (e.g. the biting teeth of a three-bit drill).

The use of LMD technology with a fiber laser for cladding processes solves many problems generated when using other previously available cladding technologies. Other surfacing technologies include: gas surfacing OAW, arc surfacing with a non-consumable electrode in a gas shield—GTAW and plasma surfacing PTAW. One of the basic problems of the above-mentioned technology is the lack of repeatability of the process during surfacing. In the disclosed method, the additional material (in the form of powder) is melted with a laser light beam while melting the substrate. The shielding gases used are generally argon and a mixture of argon and hydrogen. In fiber lasers, the active medium is an optical fiber doped with selected elements, such as Ho, Tm, Er, Nd. The length of the emitted light depends on the chemical composition of the semiconductor material. Appropriate selection of fiber laser parameters, (including: light power of the optical fiber) enables the generation of a laser beam adapted to the entire cladding process.

### BRIEF DESCRIPTION OF DRAWINGS

In order to provide a more complete understanding of the claimed invention and its advantages, the following description contains an explanation of possible exemplary embodiments thereof with reference to the figures of the accompanying drawings, in which identical reference numerals designate identical parts and which illustrate the following:

FIG. 1 shows a diagram of a robotic station for laser cladding of powder layers using LMD technology;

FIG. 2 is a perspective view of a robotic station for laser cladding of powder layers using LMD technology.

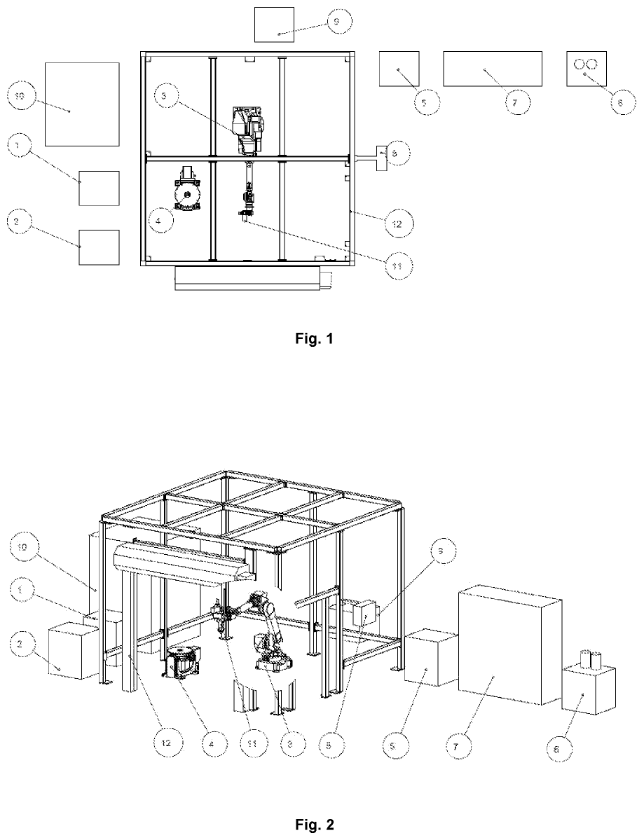

1. Fiber laser source; 2. Laser and optics cooler; 3. Six-axis robot; 4. Two-axis positioner; 5. Robot controller and IT cabinet; 6. Powder feeder; 7. Central control unit; 8. Operator panel; 9. Process head powder nozzle cooler; 10. Filter-ventilation system; 11. LDM process head; 12. Protective cabin.

### EMBODIMENTS

According to one embodiment of the invention, the process for producing steel products, in particular cone details, using the additive manufacturing method in the laser metal deposition (LMD) process, includes the following steps:
a. pre-heating the cone to a temperature ensuring the connection of the powder and the substrate; this minimizes the risk of cladded cracks,
b. mounting the cone on a two-axis positioner 4, enabling the cone to be manipulated in two rotary axes by the robot 3. This stage affects the accuracy of the cladding and the final shape of the cladding. The robot installed on a pedestal moves in six degrees of freedom, allowing flexible adaptation to various shapes and sizes of welded elements. Thanks to this, the robot frame can precisely move in the space around the cone;
c. feeding the composite powder to the powder nozzle of the process head 9 through the powder feeder 6. The robot arm is equipped with a process head 11 responsible for the cladding process. The head has a special high-precision optical system that controls the laser stream and a precise process nozzle that is responsible for feeding powder into the pool. The integrated powder feeder enables constant material feeding during cladding. The feeder is composed of two cylinders, allowing mixing of the matrix and reinforcing phase in real time.

The use of separate cylinders prevents heavy fractions from falling to the bottom, which occurs when working with a single-cylinder powder feeder. Maintaining a uniform powder composition is a problem in longer processes;
d. melting the composite powder with the light beam of fiber laser 1 while melting the substrate;
e. surfacing of cone details using the process head 11 while the molten powder layer integrates with the substrate or previous cladded layers;
f. repeating the cycle until the desired three-dimensional object is obtained, preferably until no more than 3 cladded layers are obtained with a total thickness of 1.4 to 4 mm

The matrix of parameters that are included in the scope of the process include: light power of the optical fiber, energy and pulse of laser light, power of the laser light beam, duration and frequency of the pulse, size of the laser beam focus. In order to determine the optimal process conditions, parameters were adjusted, the values of which are summarized in Table 1.

The powder used in this process is disclosed in a patent application PL436889A1 and has the following composition: 32-48% vol. nickel matrix, 12-18% vol. TiB₂ and 40-50% vol. tungsten carbide particles.

TABLE 1
The main parameters of the cladding process
Process parameters

| | |
|---|---|
| Nominal output power [W] | 5000 ÷ 10000 |
| Wavelength of radiation [nm] | 900 ÷ 1080 |
| Beam quality | max 8 mm mrad |
| Pilot laser power [Mw] | 0.4 ÷ 0.5 |
| Laser spot diameter [mm] | 4 ÷ 8 |
| Laser power [W] | 1150 ÷ 1550 |
| Working distance [mm] | 25 ÷ 28 |
| Powder gradation [μm] | 45 ÷ 250 |
| Transporting gas [Ar] | 4 ÷ 8 |
| Shielding gas [Ar] | 10 ÷ 14 |
| The number of layers | 1 ÷ 3 |
| Powder flow [g/min] | 20 ÷ 30 |
| Stirrer [%] | 5 ÷ 30 |
| Cladding speed [mm/sec] | 4 ÷ 9 |
| Distance between stitches [mm] | 2.2 ÷ 3.0 |
| Cladded layer thickness [mm] | 1.5 ÷ 4.0 |
| Heating temperature [° C.] | 150 ÷ 350 |
| Melting efficiency [%] | 55 ÷ 85 |

According to another embodiment of the invention, a robotic station for producing drilling tools includes a 6-axis robot 3 for performing operations with the process head 11, a powder nozzle 9 cooler for the process head 11, a robot controller and an IT cabinet 5 managing the movement of the robot 3, fiber laser source 1 providing light energy to melt the composite powder fed through the powder feeder 6, two-axis positioner 4 setting the elements in appropriate positions during the cladding process, cooler for the laser source 2, central control unit 7 for controlling the components of the robotic station, operator panel 8, system cleaning 10, which cleanses the interior of the chamber from dust generated in the cladding process, the protective cabin 12 and the control cabinet 5 containing devices ensuring communication and control of the complete system of hardware elements, i.e. synchronization of the movements of the robot and the positioner.

The basic element of a robotic station is the industrial robot arm on which the process head is mounted. The head is responsible for surfacing the drill bit details. The robot installed on a pedestal moves in six degrees of freedom, allowing the head to maintain a constant angle relative to the surface to be cladded, regardless of the shape or size of the cladded elements. Due to this, the robot arm can precisely move in the space around the cone. The robot arm is equipped with a process head responsible for the surfacing process. The head has a special high-precision optical system that controls the laser stream and a precise process nozzle that is responsible for feeding powder into the pool. The robot is programmed using a CAM system that allows precise programming of the robot's movement path and welding parameter settings based on a 3D model.

Additionally, the positioner rotates on two cartesian axes, and its movements are synchronized with the robot's movements. Thanks to this, the detail can be precisely positioned, which results into accurate and repeatable cladding.

Optimization of a high-power laser source and the use of a fiber laser allows, with properly selected parameters, to obtain an appropriately profiled laser beam. This allowed us to obtain a solution with a high level of energy efficiency and low cooling requirements, which contributes to their efficient operation in various variants of cladding drill bit details.

To prevent overheating of the process head, the station is equipped with an efficient cooling system. The system cools both the head optics and the process nozzle itself.

Another component is the powder feeder, which supplies the appropriate amount of cladding powder. This ensures a controlled cladding process and minimizes losses of fed material. The integrated powder feeder allows constant material feeding during cladding. The feeder is composed of two cylinders, allowing mixing of the matrix and reinforcing phase in real time. The use of separate cylinders prevents heavy fractions from falling to the bottom, which occurs when working with a single-cylinder powder feeder. Maintaining a uniform powder composition is a problem in longer processes. The integrated powder feeder helps ensure material uniformity.

The assembly of the system of elements of the robotic station takes place in the control cabinet, which synchronizes the movements of the robot and the positioner to ensure optimal cladding of the drill bit details.

The control cabinet and the robot controller are essential elements of the entire system that provide control over the cladding process and properly control the robot and the process head.

This solution allows for wide use in the industry of producers of drilling tools and equipment. Thanks to the automation, precision and control of the cladding process, it contributes to increasing the efficiency and durability of drilling tools. Motion kinematics and control software ensure accurate and repeatable results, which translates into high quality of the final product.

Precise and controlled cladding of the of the three-bit steel detail results in perfect fit and increased durability. Composite powder cladding guarantees the durability and strength of the drill bit teeth, which contributes to their long-term reliability.

The properties of cladded layer made with composite powder are shown in Table 2.

TABLE 2
Parameters of the cladded layer made with composite powder.

| Impact resistance | KCV 46.6 J/cm² | |
|---|---|---|
| Abrasive wear resistance according to ASTM G-65 | 0.05 | [g] |
| Density of the cladded layer | 9.899 | [g/cm³] |
| Measuring the hardness of the matrix | 831.6 | HV |
| Measurement of the hardness of the reinforcing | 2201.9 | HV |
| phase | | |
| Measurement of global layer hardness | 60.0 | HRC |

1. A process of producing a cone using an additive manufacturing method in the laser metal deposition (LMD) process, including the following steps:
a. preheating the cone to a temperature ranging from 150 to 350° C.,
b. mounting the preheated cone on a two-axis positioner (4),
c. feeding a composite powder to a powder nozzle of a process head (9) through a powder feeder (6), the composite powder containing 32-48 vol % nickel matrix, 12-18 vol % TiB₂ and 40-50 vol % tungsten carbide particles,
d. melting the composite powder with a fiber laser light beam (1) with a nominal output power of 5,000 to 10,000 W, while melting the surface of cone,
e. cladding the cone using the process head (11), with the layer of melted composite powder from step d., with a cladding speed of 4 to 9 mm/s, during which the layer of molten powder integrates with the surface of cone or previous cladded layers,
f. repeating the cycle until no more than 3 cladded layers are obtained with a total thickness of 1.4 to 4 mm.

2. The process according to claim 1, wherein the laser radiation wavelength is from 900 to 1080 nm, the laser power is from 1150 to 1550 W, the laser spot diameter is from 4 to 8 mm.

3. The process according to claim 1, wherein the gradation of the composite powder is from 45 to 250 μm and the powder flow is from 20 to 30 g/min.

4. The process according to claim 1, wherein the powder melting efficiency is from 55 to 85%.

5. A cladded layer obtained by the process defined in claim 1.

6. The cladded layer according to claim 5, having an impact resistance KCV of 46.6 J/cm².

7. The cladded layer according to claim 5, having a density of 9.899 g/cm³.

8. The cladded layer according to claim 5, wherein the abrasive wear resistance according to the ASTM G-65 standard is 0.05 g.

9. A robotic station for producing drilling tools, containing a six-axis industrial robot (3) for performing operations with the LMD process head (11), a powder nozzle cooler for the process head (9), a robot controller and an IT cabinet (5) managing the movement of the robot (3), fiber laser source (1) providing light energy to melt the composite powder fed through the powder feeder (6), two-axis positioner (4) setting the elements in appropriate positions during the cladding process, laser source and optics cooler (2), central control unit (7) for controlling the components of the robotic station, an operator panel (8), a filter-ventilation system (10) that cleans the interior of the chamber from dust generated in the cladding process, and a protective cabin (12).
